(19) United States
(12) Patent Application Publication
(10) Pub. No.: US 2007/0150746 A1
(43) Pub. Date: Jun. 28, 2007

(54) Portable storage with bio-data protection mechanism & methodology

(76) Inventor: Li-Kuo Chiu, Taipei City (TW)

Correspondence Address: LOWE HAUPTMAN BERNER, LLP, 1700 DIAGONAL ROAD, SUITE 300, ALEXANDRIA, VA, 22314, US

(21) Appl. No.: 11/316,882

(22) Filed: Dec. 27, 2005

(51) Int. Cl. H04K 1/00

(52) U.S. Cl. 713/186

(57) ABSTRACT

A portable storage device containing bio-data protection mechanism and its protection methodology including a host interface connected to a host of terminal, a controller, a fingerprint sensor, a storage device interface, and a large capacity storage unit; drives and applications being loaded from the storage unit and installed in the host for the host to notify the controller to control the sensor in reading user's fingerprint data pending recognition; the host judging if the user's fingerprint data pending recognition matches the template fingerprint data stored in the storage unit; and the specific block hidden in the storage unit appearing on the host for the host to access to the storage unit by means of encryption/decryption algorithm.

### FIELD OF THE INVENTION

The present invention is related to a portable storage with bio-data protection mechanism and methodology, and more particularly, to one that is designed such that its hardware automatically provides the function of file protection by means of bio-data.

### BACKGROUND OF THE INVENTION

Conventionally, the coding method is the most popular approach to protect the secret of personal data. However, the coding method is found with some disadvantages, such as that the user fails to always remember the code, and that the user is at the risk of having his code to be broken by others. Therefore, bio-recognition methods by using personal bio-data, e.g., fingerprint, vocal password, handwriting, and iris have been gradually developed into sound and effective ways of data protection. The bio-recognition method has the advantage that since the biological feature is an integral part of a human body, one does not have to particularly memorize for the recognition, and such biological feature is naturally burglar proof. Furthermore, the protection method incorporating with fingerprint bio-feature is not only considered as security-tight, but also allows convenient application.

The invention of fingerprint sensor IC in recent years helps make compact electronic product integrated with fingerprint recognition device a feasible technology while opening up a brand new area for personalized application, i.e., the portable electronic product adapted with fingerprint recognition function, particularly in the area of protection for the storage medium that has become a key development item in the incorporation of bio-recognition functions. Two decades ago, U.S. Pat. No. 4,582,985 already taught a protection method for the storage medium by fingerprint verification to protect personal data stored in personal ID card. Data under protection can only be outputted for subsequent process or certification procedure after the fingerprint recognition procedure is cleared. The device, with its lateral dimension same as that of the credit card generally available in the market, includes a fingerprint sensor, an image processor, a recognition module, and a memory. It is related to a standing-alone fingerprint recognition device (i.e., fingerprint retrieval and recognition are executed within the same device) even though the subject matter of its application is to prevent counterfeit of credit card or similar card. However, the comparatively higher production cost of such a standing-alone fingerprint recognition device prevents any meaningful sales promotion since other than the fingerprint sensor, both of the image processor and recognition module require higher-end microprocessor, e.g., 32-bit RISC processor or DSP IC.

Furthermore, those inventions including U.S. Pat. No. 6,213,403, WO 02/42887A2, U.S. Pat. No. 6,213,403, EP 124079A1, USA Patent Application No. 2003/005337, and GB2387933 disclose the similar device that protects the data stored in a built-in memory by means of fingerprint recognition. Those inventions are actually similar to the storage device adapted with fingerprint sensor disclosed in the U.S. Pat. No. 4,582,985 with each configuration of the fingerprint recognition is essentially comprised of a standing-along fingerprint recognition device (i.e., both of the fingerprint retrieval and recognition are executed within the same device).

Those prior arts described above share a common feature; that is, each of them provides a standing-alone fingerprint recognition device containing fingerprint sensor, fingerprint icon process and recognition IC. The standing-alone design though gives it advantage that the installation of fingerprint applications into the host of the terminal might not be required to provide in turn the convenience of hot plug-and-play (PnP), another important issue is exposed - expensive cost to include the addition of a fingerprint icon process and recognition IC and the related design. Usually, the recognition IC must be of 32-bit RISC or DSP to fast process fingerprint recognition; and the cost of the processor generally increases as its operation speed and process capability increases. The RISC or DSP costs nowhere under US$6,000.

To solve the problem of higher production cost, the optimal way is to have the microprocessor in the terminal host to execute fingerprint icon process and recognition, thus to effectively achieve the purpose of cost reduction. As published in USA Application No. 2003/005337, it teaches to have first the fingerprint process and recognition applications installed in a terminal host for the microprocessor built in the terminal host to execute fingerprint icon process and recognition. However, the major problem of such a design is that the user is deprived of the handy feature of hot PnP at the host of other terminal, or the user has to spend lot of efforts in SW installation.

Accordingly, some of the inventors of the present invention proposed in their ROC application titled “Memory Containing Fingerprint Sensor & Data Protection Method” (Application No. 092133887) solutions to cope those problems described above. Wherein, a function to automatically download fingerprint applications (including those for fingerprint icon process and recognition) into a terminal host without first installation of the fingerprint icon process and recognition SW into the terminal host is provided; meanwhile the microprocessor built in the terminal host is used to execute fingerprint icon process and recognition to achieve the purposes of convenient use and effective cost production.

Each of those prior arts described above takes advantage of the human fingerprint to protect data in a memory, particularly, a non-volatile one. However, in terms of other types of portable large-capacity storage unit, they define an important orientation for future development, particularly in magnetic hard disk and optical disk.

Accordingly, some of those inventors of the present invention filed an application (R.O.C. Application No. 093112282) titled “Portable Encryption Storage Containing Bio-recognition and Its Data Protection Method” to disclose methods to solve those problems challenging those prior arts by using human fingerprint to protect data in a portable large-capacity storage unit. However, the development of a storage containing bio-recognition adaptable to other types of portable large capacity storage unit at the same time has become another important orientation on considering costs, flexibility of space for the operation of the storage, and use of various encryption/decryption algorithms.

### SUMMARY OF THE INVENTION

The primary purpose of the present invention is to provide a portable storage device containing bio-data protection mechanism. Wherein, a portable large capacity storage unit is connected to a host at a terminal, and a controller to jointly work with the host to provide a portable storage device containing a fingerprint sensor without increasing the cost of the large capacity storage unit for the process of data containing fingerprint characteristics of an individual are used instead of code. The controller enables the host to hide its fingerprint sensor and the access to the large capacity storage unit so simplify the control method of the host, thus to process encryption/decryption on the HW and SW of the device.

Another purpose of the present invention is to provide a portable storage device containing bio-data protection mechanism. Wherein, the large capacity storage unit is divided into two blocks. On block is related to a public block functioning as the read-only space for the storage of those fingerprint applications that can be read by the system. Another block related to a hidden block that cannot be detected by the system is used for the storage of private data including characteristics of the fingerprint of the user, user information, programs, encryption golden key, and electronic certificate with all data encrypted so to provide an integral data protection and hiding method. The process to protect the private data by encryption and decryption is done by downloading the data to the host of the terminal for the applications installed in the host to process, or by having the data to be processed by an encryption and decryption engine built in the controller before being stored in the hidden block once again.

To achieve the purposes, the prevent invention is comprised of a host interface, a controller, a fingerprint sensor, a storage device interface, and a large capacity storage unit that can be connected to a host at a terminal. The controller is used for handshaking with the host to load and install drives and applications from the large capacity storage unit into the host; the host through the applications notifies the controller to control the fingerprint sensor to read the fingerprint data pending recognition of the user; and the host applications process the data pending recognition to check if it coincides with that of the template stored in the large capacity storage unit. Accordingly, the specific block hidden in the portable large capacity storage unit appears in the host at the terminal to become accessible by encryption/decryption algorithm.

Another purpose yet of the present invention is to provide a protection method for the portable storage device containing bio-data protection mechanism. To achieve the purpose, the controller communicates with the host at the terminal through the host interface, thus to load and install those adaptable drives and applications into the host at terminal and to enter into a fingerprint login mode or fingerprint certification mode. In the fingerprint login mode, the host at the terminal notifies the controller to control the fingerprint sensor to read the template fingerprint data of an authorized user and transmit the template fingerprint data to the host at the terminal to be processed by the applications installed in the host. The data so processed are then transmitted to the hidden block for storage. In the fingerprint certification mode, the controller transmits the template fingerprint data to the host at the terminal, where the controller is notified by the host to control the fingerprint sensor to read the fingerprint data pending recognition of one of the users and to transmit the fingerprint data pending recognition to the host. Those applications installed in the host process both of the fingerprint data pending recognition and the template fingerprint data to judge if both data substantially match. If yes, the user's database in the hidden block is enabled to generate a virtual logic disk for the host to access; if not, the user's database in the hidden block is disabled to prevent access by the host.

### BRIEF DESCRIPTION OF THE DRAWINGS

FIG. 1 is a block chart of a portable storage device containing bio-data protection mechanism of the present invention.

FIG. 2 is a schematic view showing the steps of a protection method for the portable storage device containing bio-data protection mechanism of the present invention.

FIG. 3 is a schematic view showing that a large capacity storage unit of the portable storage device containing bio-data protection mechanism of the present invention is divided into various independent areas.

### DETAILED DESCRIPTION OF THE PREFERRED EMBODIMENTS

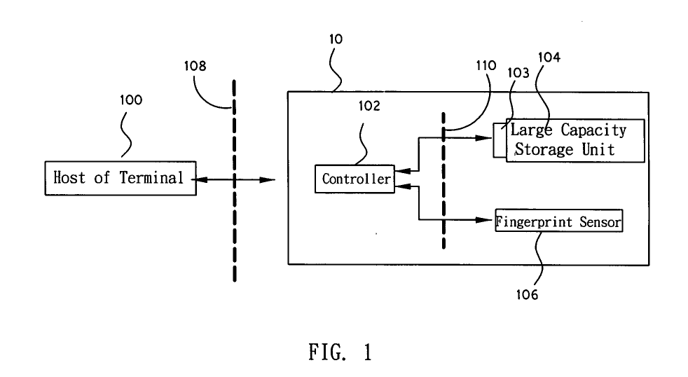

Referring to FIGS. 1, 2, and 3 for a block chart of a portable storage device 10 containing bio-data protection mechanism of a preferred embodiment of the present invention, the portable storage device 10 includes a controller 102, a storage device interface 103, a large capacity storage unit 104, a fingerprint sensor 106, and a host interface 108 connected to a host 100 at a terminal (e.g., a computer system) to provide SW or HW encryption/decryption protection. Wherein, the storage device interface 103 in the preferred embodiment is related to a Smart Media interface (NAND Flash interface), and it may be related to a PCMCIA, CF, IDE, memory Stick, SD, xD or any other standard interface for the device to provide data protection method for any type of large capacity storage unit 104. The host interface 108 is related to a USB interface, and it may be related to a PCMCIA, PCI-E (PCI EXPRESS) or a high-density transmission connection interface (IEEE 1394) or any other standard interface. The host interfaced 108 is connected to the host 100 at the terminal, and the controller 102 is connected to the host interface 108 such that the controller 102 is connected to the host 100 through the host interface. An expansion slot 110 of the storage device interface 103 is connected to the large capacity storage unit 104. The function of the controller 102 is to communicate with the host 100 at the terminal while controlling the large capacity storage unit 104 and the fingerprint sensor 106. The large capacity storage unit 104 must include one or a plurality of IC, memory or any other storage unit for data storage, e.g., a flash memory, PROM, disk, or any other programmable memory allowing erasable by electricity. The large capacity storage unit 104 is divided into a public block 104A for the storage applications containing fingerprint application, and a hidden block 104B for the storage of one or a plurality of template fingerprint data, a encryption/decryption golden key, and a lot of data pending protection. The controller 102 is capable of transmitting the encryption/decryption golden key into the host 100 at the terminal for the applications installed in the host 100 to encrypt/decrypt the data pending protection accessible from the hidden block 104B by means of the encryption/decryption golden key.

The fingerprint sensor 106 relates to a stationary type that detects the area of the fingerprint firmly placed upon the sensor, or a slide type that detects the fingerprint sliding over the top of the sensor. The fingerprint sensor 106 subject to the access control by the controller 102 catches the real-time fingerprint data for process. The host 100 at the terminal executes template comparison between the real-time fingerprint data so caught and the previous template fingerprint data. The template fingerprint data relate to the original fingerprint data left by the owner of the portable storage device 10 of the present invention upon using the device 10 for the first time. The original fingerprint data become the reference for the comparison with the subsequent fingerprint data. Therefore, the fingerprint sensor 106 is connected to the controller 102 to detect the template fingerprint data of an authorized user, and to further detect another log of fingerprint data pending recognition of a user for the comparison with the template fingerprint data.

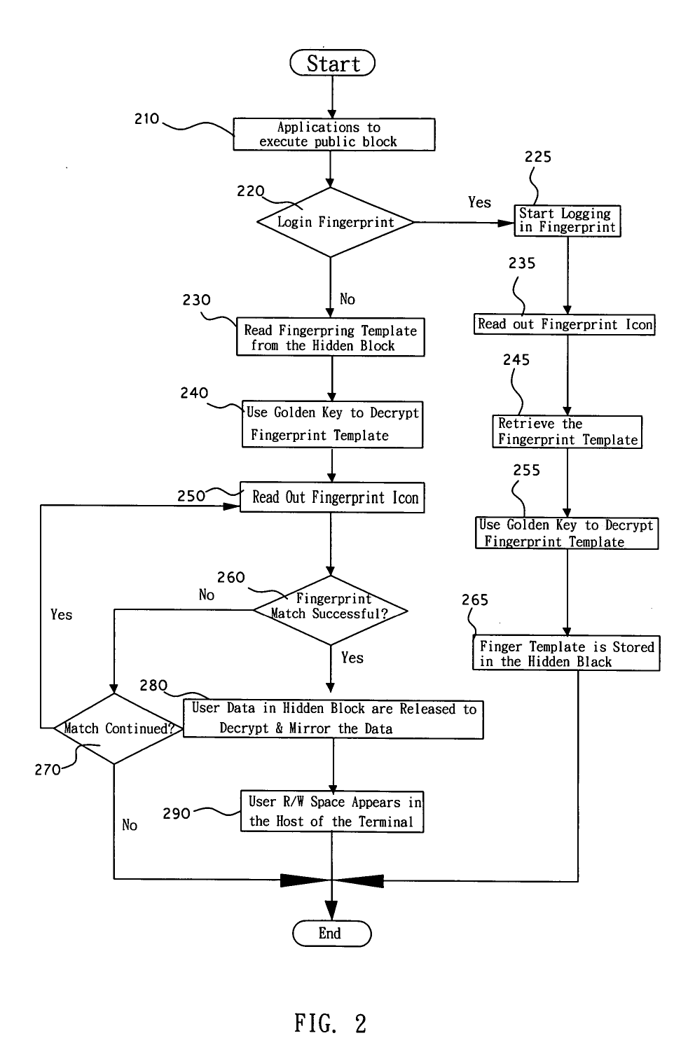

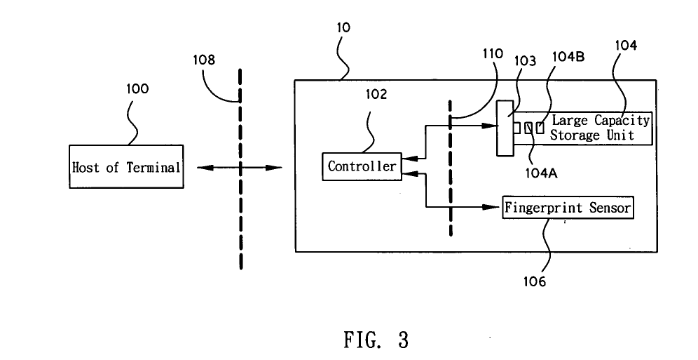

As illustrated in FIGS. 2, and 3, a protection method of the present invention for the protection of the data stored in the host 100 at the terminal connected to the portable storage device 10 is comprised of the following steps. First, the controller 102 communicates with the host 100 at the terminal through the host interface 108 for the host 100 to load and install those drives and applications (including fingerprint applications) such as those exercisable in the public segment in Step 210 adaptable to the operation system of the hose 100 into the host 100 at the terminal. A window appears on the host 100 upon entering the fingerprint login phase as illustrated in Step 220 for the user to select or to automatically enter a “Start to Log In Fingerprint” mode as illustrate din Step 225, or to read from the hidden block a fingerprint certification mode of the fingerprint plate as illustrated in Step 230. Upon entering into the Start to Log In Fingerprint” mode, the host 100 at the terminal notified the controller 102 to control the fingerprint sensor 106 in reading the template data of the fingerprint of an authorized user and transmit the fingerprint template data into the host 100 (as indicated in Steps 235, 245). Meanwhile, the host 100 processes the fingerprint template data using the fingerprint applications and transmits the processed fingerprint template data to the hidden block 104B in the large capacity storage unit 104; alternatively, the fingerprint applications has the template fingerprint data encrypted using the golden key (as indicated in Step 225) before transmitting the encrypted fingerprint template data to the hidden block 104B in the large capacity storage unit 104 for storage (as indicated in Step 265).

To enter into the fingerprint certification mode, the controller 102 reads form the hidden block 104B in the large capacity storage unit 104 the template fingerprint data (as indicated in Step 230) for the template fingerprint data to be transmitted into the host 100 at the terminal before being decrypted using the golden key (as indicated in Step 240). The host 100 then notifies the controller 102 to control the fingerprint sensor 106 in reading and transmitting to the host 100 the fingerprint data pending recognition of a user (as illustrated in Step 250). The host 100 compares both lots of the fingerprint data pending recognition and the template fingerprint data to judge if both lots of data substantially match. If yes, the user database in the hidden block 104B is enabled to mirror a logic disk for the host 100 to access (as indicated in Step 280); or the user database in the hidden block 104B is disabled to prevent access by the host 100 or to enquire the user if further comparison for certification is warranted or not (as indicated in Step 270).

The method to control the large capacity storage unit by using the controller 102 in the present invention is done by dividing the large capacity storage unit 104 into various independent blocks to separately storage data of different natures. As illustrated in the preferred embodiment of the present invention, the large capacity storage unit 104 is divided into the public block 104A and the hidden block 104B as illustrated in FIG. 3.

Once the portable storage device 10 of the present invention is connected to a terminal system, the latter takes the former as an independent disk while automatically linking to the independent public block 104A in the memory module 104 sot to show on a display of the terminal of options of the fingerprint application files for the user to select to execute the fingerprint applications, e.g., in a form of a fingerprint match picture.

Once the user completes to execute the fingerprint applications in the public block 104A and successfully completes the certification, the controller 102 automatically reads from the hidden block 104B the user's database to mirror a logic disk for the host 100 to access to. Such mirrored logic disk out of the user database of the hidden block 104B is referred as a virtual logic disk. Relatively, a switched picture appears on the display of the terminal system, i.e., the picture is switched to the virtual logic disk of the hidden block 104B under protection to display the data under protection in the hidden block 104B for the user to have free access to the data.

Upon using the device of the present invention, the controller 102 will first automatically download the fingerprint applications from the public block, and after having successfully run the fingerprint applications displays at the host 100 the virtual logic disk in the hidden block 104B. Whereas the applicant of the prevent invention in its ROC Application No. 092133887 titled “Memory Storage Device Containing Fingerprint Sensor & Data Protection Method” disclosed that the controller 102 is designed with memory independent division and control functions, the automatic download and picture switching functions are provided to differ the device of the present invention form the prior art by taking advantage of the microprocessor in the terminal system to process and recognize while providing the automatic download of applications including the fingerprint applications.

It is to be noted that any application installed in the public block 104A of the present invention is read-only file that prevents any alteration. The hidden block 104B requires special programs for direct communication with the controllers and the system is also prevented from detecting the hidden block 104B. The size of the hidden block 104B may be readjusted depending on the design and is provided for the storage of template fingerprint data, encryption golden key, electronic certificate, user's database and other private information. As required, the hidden block 104B maybe further divided into multiple user databases. In such case, the disk mirrored by the host 100 in relation to the device of the present invention may mirror different virtual logic disks (in the hidden block 104B of the device of the present invention) corresponding to those different user databases.

Accordingly, multiple virtual logic disks (in the hidden block 104B of the device) and a read-only logic disk (in the public block 104A of the device) can be displayed in the host 100 at the terminal of the present invention. The virtual logic disk will show its disk code in the host 100 for the user to execute data storage and deletion in the space under the disk code. The data are expressly displayed in text when read under the disk code by the user, and are encrypted when stored in the hidden block 104B of the device 10 and the corresponding user database is hidden by the controller 102 of the device 10 to prevent the host 100 from detecting the hidden block. Therefore, all user information is hidden whenever the user database in the hidden block 104B is disabled.

Now referring to FIGS. 1, and 2 for the description of the process flow of the application system of the present invention, first, the portable storage device 10 containing bio-data protection mechanism of the present invention is plugged into a slot at the host 100, the controller 102 upon the initial power is on communicates with the host 100 through the host interface 108 to read the information block into an SRAM of the controllers. Depending on the data loaded into the SRAM information block, the controller 102 responds to the request made by the host to carry out allotment for the large capacity storage unit 104 and take it as a logic disk. Under the control by the controller 102, the host 100 automatically reads out and executes those applications in the public block 104A of the large capacity storage unit 104, without the necessity of manual installation of drives and applications by the user.

The host 100 then directly runs the applications and receives a command from an authorized user (to be carried out as guided by a pop-up window) to notify the controller 102 to control the fingerprint sensor 106 in reading the template fingerprint data of the authorized user while the data are transmitted into the host 100. The host 100 processes the template fingerprint data using those applications and transmits the processed template fingerprint data into the hidden block 104B for storage. Accordingly, the user may store the private data into the hidden block 104B for confidential purpose. When the user carries the portable storage device 10 to a host 100 at another terminal, the controller 102 by handshaking with the host 100 via the host interface 108 responds to the request issued by the host 100 to carry out allotment for the large capacity storage unit 104 and take it as a logic disk while loading into, installing and running one of those applications at the host 100. When the applications in the host 100 judges that the template fingerprint data have been stored in the hidden block 104B of the large capacity storage unit 104, or the controller 102 has notified the host 100 about the status that the template fingerprint data have been stored in the hidden block 104B, the controller 102 transmits the template fingerprint data into the host 100. The host 100 notifies through direct execution of the applications and the reception of a user command through the applications the controller 102 to control the fingerprint sensor 106 in reading the fingerprint data pending recognition of a user, and to transmit the fingerprint data pending recognition into the host 100. The host 100 using the applications processes the fingerprint data pending recognition and the template fingerprint data to judge if both substantially match. If yes, the user database in the hidden block 104B is enabled to produce a virtual logic disk for the host 100 to access to; if not, the user database in the hidden block 104B is disabled to prevent access by the host 100.

To further protect the confidential data in the hidden block 104B of the memory module 104, the encryption golden key in the hidden block 104B is used to exercise encryption/decryption to the confidential data in the hidden block 104B (to be processed by those applications). Under the control by the controller 102, the encryption/decryption golden key can be transmitted into the host 100. Accordingly, those applications installed in the host are permitted to carry out encryption/decryption process for the protected data accessed from the hidden block 104B using the encryption/decryption golden key.

Through the construction of the present invention described above, the connection device visible from the host 100 at the terminal no longer contains a non-volatile memory and a fingerprint sensor; therefore, simultaneous installation of drives adaptable to the non-volatile memory and the fingerprint sensor is not required, thus the operation of multiplex control of two devices at the host 100 is not required. Instead, the connection device visible from the host 100 has only one portable storage device 10, meaning that the host 100 has only to control the operation of one device leaving the operation of the non-volatile memory and the fingerprint sensor inside the portable storage device to be controlled by the controller 102. It is to be noted that the controller 102 of the present invention may comprehensively include any other devices that control the operation of the non-volatile memory and fingerprint sensor, such as the ROM or RAM.

The prevent invention provides a portable storage device containing bio-data protection mechanism and its data protection method, and the application for a patent is duly filed accordingly. However, it is to be noted that that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A portable storage device containing bio-data protection mechanism includes
a host interface to connect the device to a terminal host;
a controller to connect to the terminal host;
a fingerprint sensor connected to the controller to detect fingerprint data pending recognition of the user;
a storage device interface; and
a large capacity storage unit connected to the controller;
the portable large capacity storage unit being divided into a public block for the storage of drives and applications; and a hidden block for the storage of fingerprint template data and data pending protection;
the controller handshaking with the host of the terminal through the host interface; drives and applications adaptable to the host being loaded and installed into the host of the terminal; the controller transmitting the fingerprint template data into the host of the terminal; the host of the terminal through those drives and applications notifying the controller to control the fingerprint sensor in reading fingerprint data pending recognition of the user and transmitting the fingerprint data pending recognition into the host of the terminal; the host of the terminal using those applications to process fingerprint data pending recognition and fingerprint template data; and the specific block hidden in the large capacity storage unit being available on the host of the terminal for access.

2. The portable storage device containing bio-data protection mechanism of claim 1, wherein an encryption/decryption golden key is stored in the hidden block, and capable of being transmitted by the controller into the host of the terminal.

3. The portable storage device containing bio-data protection mechanism of claim 2, wherein those applications installed in the host of the terminal provide encryption/decryption to the data accessed from the hidden block pending protection by using the encryption/decryption golden key.

4. The portable storage device containing bio-data protection mechanism of claim 1, wherein the host interface relates to a USB, a PCMCIA, a PCI-E (PCI EXPRESS) or a high-density transmission interface (IEEE 1394).

5. The portable storage device containing bio-data protection mechanism of claim 1, wherein the storage device relates to a Smart Media, (NAND Flash), a PCMCIA, CF, IDE, Memory Stick, SD, xD or any other standard interface.

6. The portable storage device containing bio-data protection mechanism of claim 1, wherein the fingerprint sensor relates to a stationary type or slide type of fingerprint sensor.

7. A data protection methodology for a portable storage device containing bio-data protection mechanism, the portable storage device including a host interface for the device to connect to a host of a terminal, a controller connected to the host interface, a fingerprint sensor connected to the controller to detect user fingerprint template data, and a large capacity storage unit connect to the controller by means of a storage device interface; the large capacity storage unit being divided into a public block for storage of drives and applications and a hidden block for the storage of data pending protection; and the protection methodology being comprised of the following steps: first the controller communicating with the host of the terminal through the host interface; those drives and applications adaptable to the host of the terminal being loaded and installed in the host of the terminal; the system entering into a mode of “Starting to Login Fingerprint” or into a “Fingerprint Certification” mode; upon entering into the mode of “Starting to Login Fingerprint”, the host of the terminal notifying the controller to control the fingerprint sensor in reading the user's fingerprint template data and transmitting the fingerprint template data to the host of the terminal; the host of the terminal using the applications to process the fingerprint template data and transmitting the processed fingerprint template data to the hidden block for storage; or upon entering into the Fingerprint Certification mode, the controller transmitting the fingerprint template data to the host of the terminal; the host of the terminal notifying the controller to control the fingerprint sensor in reading the user's fingerprint data pending recognition and transmitting the fingerprint data pending recognition to the host of the terminal; the host of the terminal using its applications to process both of the fingerprint data pending recognition and the fingerprint template data to judge if both substantially matched to each other; if matched, the user's database in the hidden block being enabled to produce a virtual logic disk for the host of the terminal to access to; and if not matched, the user's database in the hidden block being disabled to prevent access by the host of the terminal.

8. The data protection methodology for the portable storage device containing bio-data protection mechanism of claim 7, wherein private information including template fingerprint data, encryption golden key, electronic certificate, and user database are stored in the hidden block.

9. The data protection methodology for the portable storage device containing bio-data protection mechanism of claim 7, wherein the hidden block is divided into multiple user databases; multiple corresponding virtual logic disks are mirrored by the host in relation to those multiple user databases; multiple different virtual logic disks in the hidden block and a read-only logic disk are displayed at the host of the terminal.

10. The data protection methodology for the portable storage device containing bio-data protection mechanism of claim 9, wherein the disk code is displayed at the host of the terminal; data storage and deletion are executed in the space under the disk code; data under the disk code are read for text display; data when stored in the hidden block are encrypted; and the encrypted data are hidden by the controller to prevent from being detected by the host of the terminal.

11. The data protection methodology for the portable storage device containing bio-data protection mechanism of claim 7, wherein a encryption/decryption golden key is stored in the hidden block; the controller transmits the encryption/decryption golden key into the host of the terminal; and those applications installed in the host of the terminal using the encryption/decryption golden key encrypt/decrypt the data accessed from the hidden block.

12. The data protection methodology for the portable storage device containing bio-data protection mechanism of claim 7, wherein the encryption/decryption process is done in the controller.
